(19) United States
(12) Patent Application Publication
(10) Pub. No.: US 2004/0070196 A1
(43) Pub. Date: Apr. 15, 2004

(54) Pipe fitting with an aid to accommodate a coring tool

(76) Inventor: Duane D. Robertson, Golden, CO (US)

Correspondence Address: DORR CARSON SLOAN & BIRNEY, PC, 3010 EAST 6TH AVENUE, DENVER, CO, 80206

(21) Appl. No.: 10/267,126

(22) Filed: Oct. 10, 2002

(51) Int. Cl. B05B 15/00; F16L 55/00

(52) U.S. Cl. 285/5

(57) ABSTRACT

A fitting for lawn sprinkler systems which have pipes of rigid, plastic such as polyvinylchloride (PVC). The fitting includes a main body with a tubular section affixed to it at about a 30 degree angle. The tubular section has an outer surface with at least a pair of posts extending outwardly from it in opposite directions. In use, the main body of the fitting can be mounted onto the outer surface of the pipe and portions of a coring tool can then be positioned substantially about the opposing posts to anchor the tool to the fitting and aid the tool in coring the pipe.

### BACKGROUND OF THE INVENTION

1. Field of the Invention

This invention relates to the field of original and replacement fittings for rigid, plastic pipes of polyvinylchloride (PVC) and more particularly to such fittings and pipes for use in lawn sprinkler systems.

2. Discussion of the Background

Early sprinkler systems for lawns were installed using either galvanized or copper pipes. These were both expensive and difficult to repair and were subsequently replaced with plastic pipes of polyethylene or polyvinylchloride (PVC). Each type of plastic pipe had its own advantages and disadvantages and many parts of the country preferred one over the other. For example, polyethylene pipes are relatively flexible and usually will not break if water freezes in them. On the other hand, PVC pipes are much more rigid and prone to damage from freezing but they can carry water at higher pressures.

The present invention relates to lawn sprinkler systems with the more rigid pipes of polyvinylchloride (PVC) or similar plastic material. These systems offer many benefits but also present many unique problems, both during the initial installation of the system and during any subsequent repairs or modifications to it. Most of these problems stem from the rigidity of the PVC pipe as it can greatly limit even minor adjustments and changes to the system. For example, the tributary or delivery pipes of PVC in such systems are usually placed in trenches dug by motorized machines. These machines can easily and relatively quickly dig the trenches but many times the trenches are not exactly straight or not exactly in the right location relative to the desired placement of the sprinkler heads. The heads are often then connected to the delivery pipes by what can sometimes be a maze of rigid elbow, Tee, and similar couplers in order to properly position each head in the desired area (e.g., a corner or edge) of the lawn and at the proper height. Such rigid connections can be both difficult and time consuming to install and repair.

For example, whenever a head is rigidly connected to the PVC delivery pipe (whether off to the side of the pipe or directly above it), damage to the system may occur from such everyday occurrences as a car simply being inadvertently driven onto the lawn and over a head or other part of the system. If only the head is damaged, the replacement is usually relatively easy to do. However, if the elbow, Tee, or other couplings rigidly connecting the head to the delivery pipe or if the pipe itself is fractured or broken, the repair can be quite time consuming and expensive. The same is also true even if the parts of the PVC system are not damaged but a head, for example, simply needs to be raised, moved, or added to an existing system.

In such cases of needed repair or modification to the parts of the system, it may be necessary to physically cut the PVC delivery pipe and insert a Tee coupler. Since the existing PVC pipe is rigid and buried, this can involve either digging up a considerable length of the pipe in order to be able to manipulate the cut ends of the pipe into a conventional, open-ended socket coupling or using a telescoping coupler. Such telescoping couplers as in FIG. 10 of applicant's U.S. Pat. No. 6,318,761 (or in U.S. Pat. No. 4,013,309 to Quick, U.S. Pat. No. 4,687,232 to Zimmerman at his FIG. 10, or U.S. Pat. No. 4,035,002 to Curtin at his FIG. 6) are quite effective but can be fairly expensive and labor intensive.

In addition to socket couplers involving the need to cut the PVC delivery pipe, right angle Tee fittings are also available that simply straddle a section of the pipe and are tapped into it. These can be used during the initial installation of the sprinkler system or during subsequent repairs or modifications to it. Such right angle Tee fittings have an upstanding portion presenting a 90 degree angle to the axis of the PVC pipe to easily tap or core into the PVC delivery pipe. However, like full socket couplers, such Tee fittings normally need at least a rigid elbow adaptor to create an extension that runs essentially parallel to the axis of the delivery pipe. Such adaptors are attached to the upstanding portion of the Tee and a short length (e.g., 6-24 inches) of very flexible hose (e.g., low density polyethylene) is then used to connect the adaptor to the head. This flexible hose section avoids the need to use a maze of additional and rigid, PVC couplings to properly position the head at the desired location and height in the lawn. However, these systems still need the adaptor elbows otherwise any direct coupling of the flexible hose section to the upstanding portion of the Tee fitting can create a very sharp angle or bend in the hose section. Such abrupt angles or bends (e.g., close to 90 degrees) in the flexible hose section between the Tee fitting and head may then create undesirable curves or even kinks in the connecting hose section to the head.

With these and other problems in mind, the fitting of the present invention was developed. With it, the initial installation of a PVC lawn system and any subsequent repairs or modifications to it can be easily and quickly made without the drawbacks of currently available systems.

### SUMMARY OF THE INVENTION

This invention involves a fitting for a lawn sprinkler system which has tributary or delivery pipes of rigid, plastic such as polyvinylchloride (PVC). The fitting is easily securable to the delivery pipe and is provided with an aid to accommodate a coring tool. In use and once the delivery pipe is cored, the sprinkler head can be easily and quickly connected to the fitting by a short section of flexible hose.

In the sprinkler system, each delivery pipe has inner and outer, cylindrical surfaces extending along a first axis. The fitting of the present invention then includes a main body with a tubular section affixed to it. The main body extends along and at least partially about a second axis and the tubular section extends along and about a third axis. The second and third axes of the fitting preferably intersect one another at about 30 degrees. The main body of the fitting has an inner surface substantially matching at least a portion of the outer, cylindrical surface of the delivery pipe wherein the main body of the fitting can be snapped onto the pipe with the first and second axes substantially parallel. The tubular section of the fitting has an outer surface with at least a pair of posts affixed to it. The posts extend away from each other and away from the outer surface of the tubular section in opposite directions along a fourth axis. The fourth axis is preferable perpendicular to the third axis of the tubular section of the fitting.

In operation, the main body of the fitting can be snapped onto and cemented to the outer, cylindrical surface of the pipe. Portions of a coring tool can then be positioned substantially about the opposing posts on the tubular section of the fitting to anchor the tool to the fitting and aid the tool in coring the delivery pipe. In doing so, the bit of the tool is advanced along the third axis of the tubular section of the fitting to tap into or core the delivery pipe. With the tool removed, the delivery pipe can then be connected via the fitting and a flexible hose section to the sprinkler head.

### BRIEF DESCRIPTION OF THE DRAWINGS

FIG. 1 is a side elevation view of the fitting of the present invention in use to connect the tributary or delivery pipe of a lawn sprinkler system to a head via a short section of flexible hose.

FIG. 2 is an enlarged view of the delivery pipe with the fitting of the present invention mounted to it.

FIG. 3 is an end view taken along line 3-3 of FIG. 2.

FIG. 4 is an end view taken along line 4-4 of FIG. 2.

FIG. 5 is a view taken along line 5-5 of FIG. 2.

FIG. 6 is a cross-sectional view of the fitting itself taken along line 6-6 of FIG. 5.

FIG. 7 is a bottom plan view of the fitting taken along line 7-7 of FIG. 6.

FIG. 8 is an end view taken along line 8-8 of FIG. 6.

FIG. 9 is a side elevational view of a coring tool that can be used with the fitting of the present invention.

FIG. 10 is a view similar to FIG. 9 showing how the coring tool can be attached or anchored to the fitting of the present invention.

FIG. 11 is a top view taken along line 11-11 of FIG. 10 showing the coring tool with its rotatable handle in an advanced position from the position of FIG. 10.

FIG. 12 is a cross-sectional view taken along line 12-12 of FIG. 11 showing the bit of the coring tool in its advanced position to core or tap into the delivery pipe of the sprinkler system of FIG. 1.

### DETAILED DESCRIPTION OF THE INVENTION

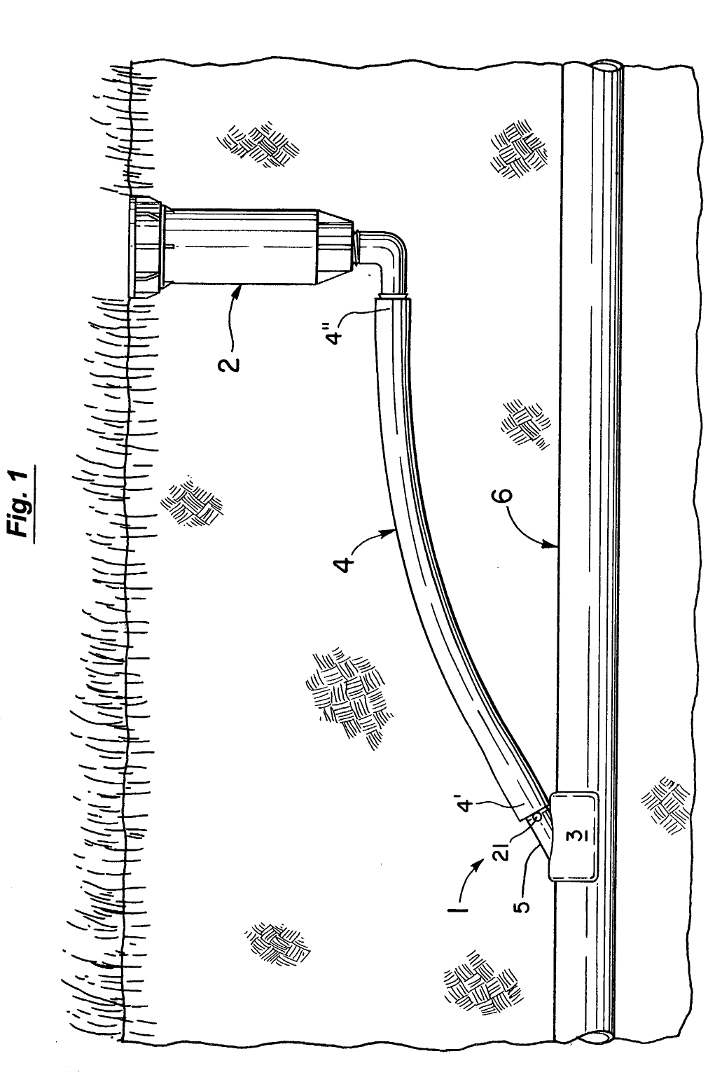

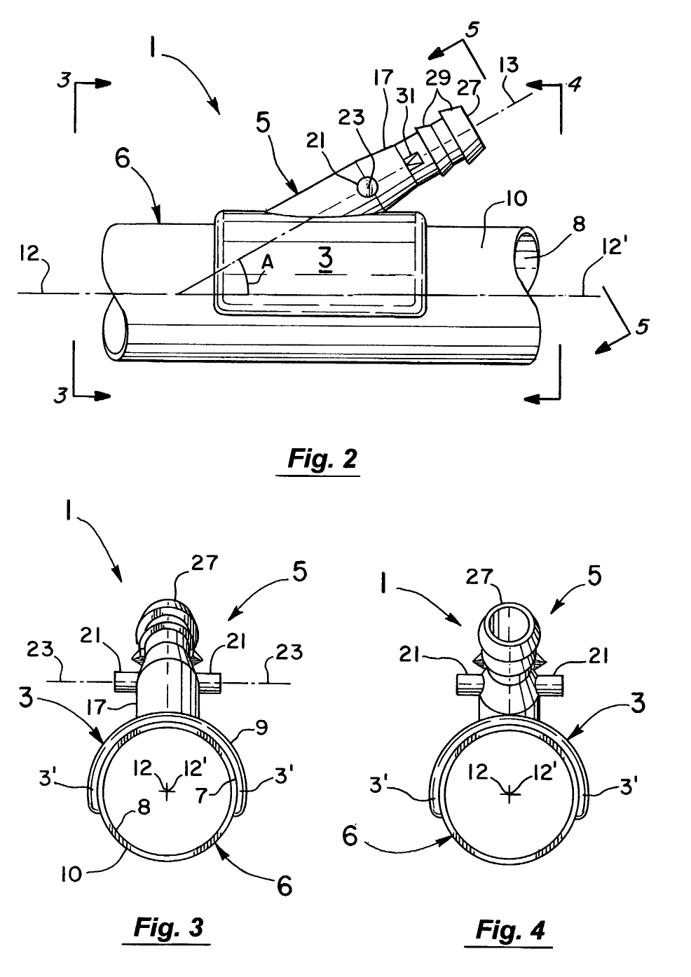

FIG. 1 illustrates the fitting 1 of the present in use to connect the sprinkler head 2 via the flexible hose section 4 to the tributary or delivery pipe 6 of a lawn sprinkler system. In the preferred embodiment as best seen in FIGS. 2-4, the fitting 1 has a main body 3 and a hollow, tubular section or insert 5. The tubular section 5 is integrally molded or otherwise affixed to the main body 3. The delivery pipe 6 as shown in FIGS. 3-4 has inner and outer, cylindrical surfaces 8 and 10 extending along and about the axis 12. The inner surface 7 of the main body 3 of the fitting 1 (see FIG. 3) is then dimensioned to substantially match and mate with at least a portion of the outer, cylindrical surface 10 of the pipe 6. The tubular section 5 of the fitting 1 as best seen in FIG. 2 preferably extends along and about the axis 13 which intersects the axis 12 at an acute angle A (e.g., 15 to 45 degrees and preferably about 30 degrees).

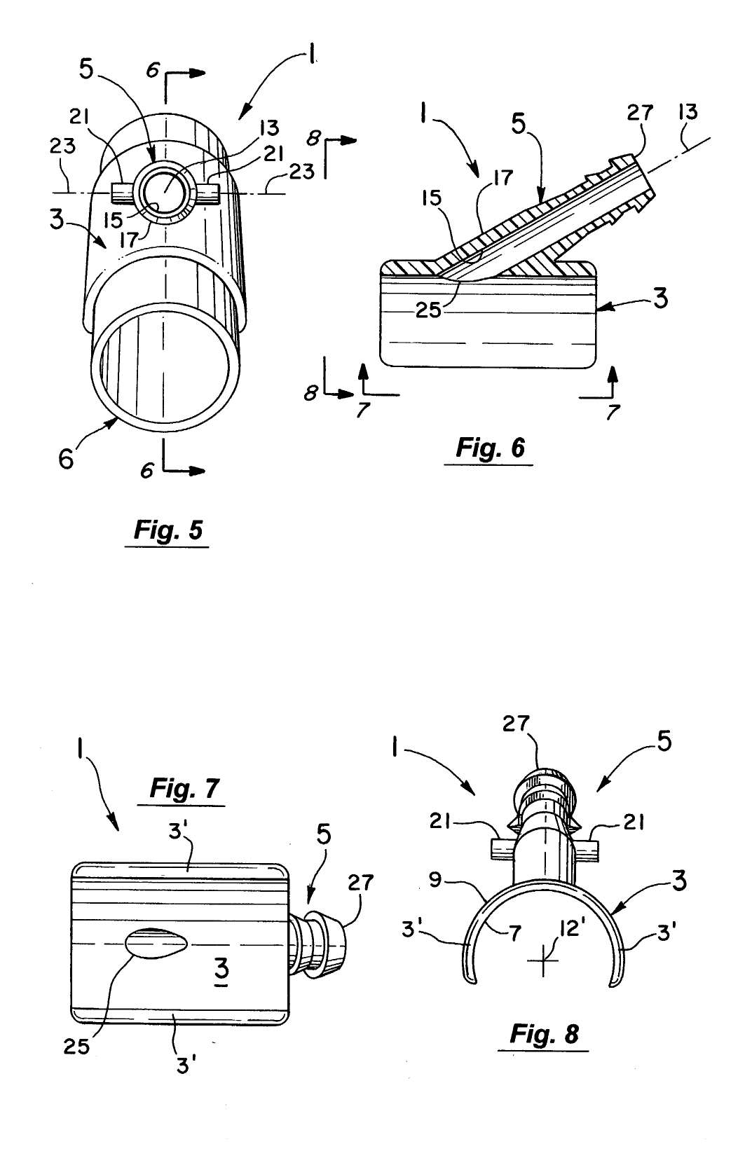

The tubular section 5 of the fitting 1 (see FIGS. 5-6) has inner and outer surfaces 15 and 17 extending along and about the axis 13. The tubular section 5 further includes at least a pair of posts 21 integrally molded or otherwise affixed to the outer surface 17 of the tubular section 5. The posts 21 as best seen in FIGS. 2, 3, and 5 extend away from each other and away from the outer surface 17 of the tubular section 5 in opposite directions along the axis 23. Axis 23 in this regard preferably intersects and is substantially perpendicular to the axis 13 of the tubular section 5.

The fitting 1 is molded of polyvinylchloride (PVC) or similar rigid plastic and as illustrated in FIGS. 6-8, the tubular section 5 of the fitting 1 is preferably open ended at 25 and 27. The main body 3 of the fitting 1 of the preferred embodiment snaps over the outer surface 10 of the pipe 6 and is cemented to the surface 10 by a sealing solvent. In this manner, the inner surface 7 of the main body 3 of the fitting 1 is fused by the chemical reaction of the solvent to the outer surface 10 of the pipe 6 to form a strong bond and seal. As indicated above, the main body 3 of the fitting 1 preferably snaps onto the pipe 6. In this regard, the radius of the inner surface 7 of the fitting 1 about the axis 12′ in FIG. 8 (i.e., before the fitting 1 is mounted onto the pipe) is slightly less than the radius of the outer surface 10 of the pipe 6 about the pipe axis 12 in FIG. 3. Consequently, the sides or legs 3′ of the main body 3 of the fitting 1 are flexed outwardly and remain slightly flexed outwardly when the main body 3 is mounted onto the outer surface 10 of the pipe 6. That is and in snapping the main body 3 onto the pipe 6 into the mounted position of FIG. 3, the axis 12′ of the stand alone fitting 1 of FIG. 8 is lowered a small fraction of an inch (e.g., 1/16) to be substantially aligned and collinear with the pipe axis 12. The inner surface 7 of the main body 3 of the fitting 1 extends less than 360 degrees and more than 180 degrees (e.g., 240) about the axis 12′ in FIG. 8 and virtually the same amount of degrees (e.g., 220) about the collinear axes 12 and 12′ in the mounted position of FIG. 3.

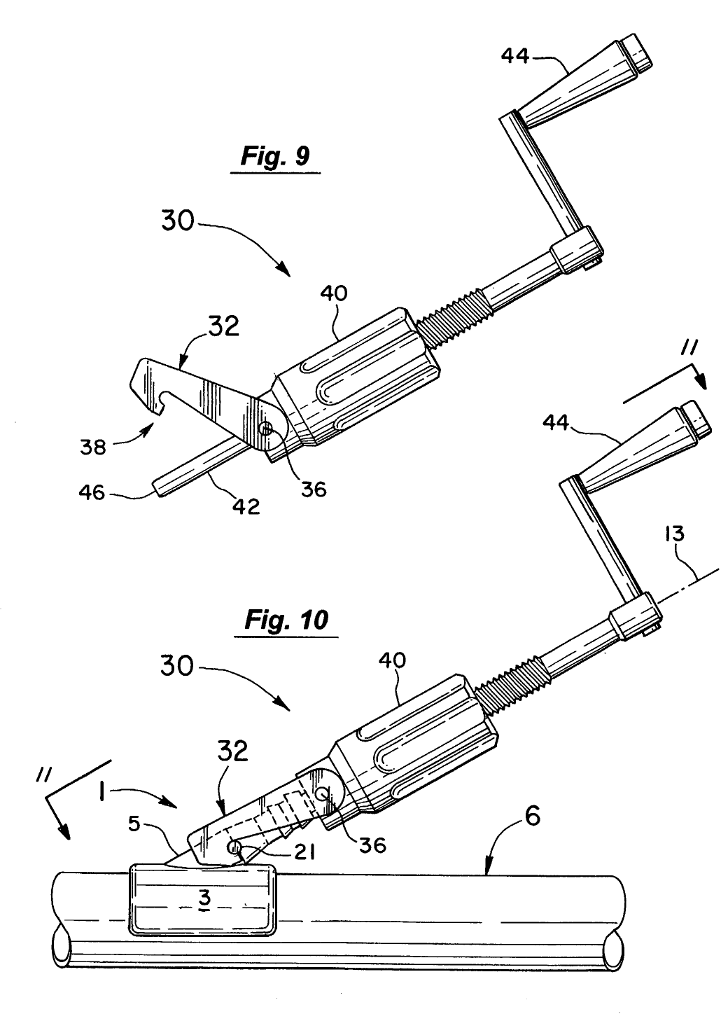

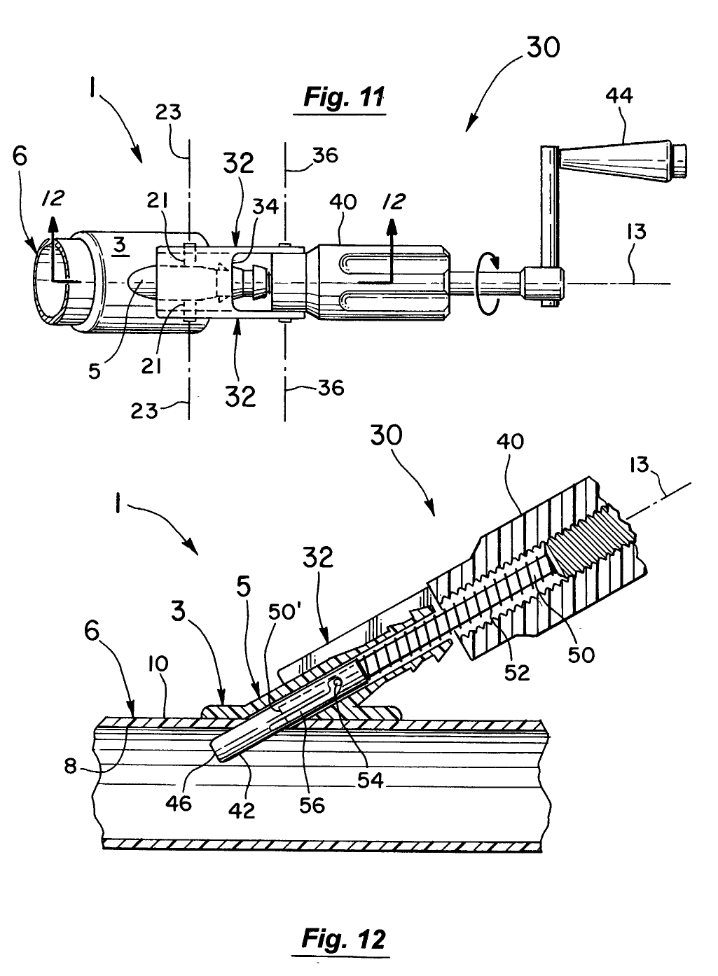

In use, the fitting 1 of the present invention can be easily and quickly snapped and cemented to the outer surface 10 of the exposed pipe 6. A coring tool 30 such as illustrated in FIGS. 9-12 can subsequently be used to tap into or core the delivery pipe 6. The illustrated coring tool 30 is manually operated but could be a powered tool if desired (e.g., electric). The tool 30 as illustrated in FIGS. 9-11 has two clamping members 32 that are integrally joined by crosspiece 34 (see FIG. 11) and mounted for pivotal movement about the axis 36. The axis 36 is preferably parallel to the axis 23 of the posts 21 of the tubular section 5 of the fitting 1 (see again FIG. 11).

In operation, the hooked ends 38 of the clamping members 32 can be pivoted about the axis 36 relative to the body 40 of the tool 30 and positioned to hook at least partially about the respective posts 21 as in FIG. 10. The bit 42 of the coring tool 30 in this position is then received within the tubular section 5 of the fitting 1. With the coring tool 30 firmly anchored via the clamping members 32 to the posts 21 of the tubular section 5, the handle 44 of the coring tool 30 can be rotated relative to the body 40 of the tool 30 about the axis 13 (see FIG. 11). This will advance or move the hollow head 46 of the bit 42 along the axis 13 to tap into or core the pipe 6 between the outer and inner, surfaces 10 and 8 of the pipe 6 (see FIG. 12). In this manner, the posts 21 of the fitting 1 thus act as an aid for the coring tool 30. Once tapped and with the coring tool 30 removed, the end 4′ of the flexible hose section 4 of FIG. 1 can be pushed over the sealing rims 29 and retaining spikes 31 of the tubular section 5 of the fitting 1 (see also FIG. 2) and down to abut against the posts 21 of the tubular section 5 as illustrated in FIG. 1. With the end 4′ of the hose section 4 so attached, the sprinkler head 2 on the other end 4″ of the hose section 4 can be positioned as desired and buried in the lawn.

In this manner and with the present invention, a fitting 1 is provided which has an aid to accommodate a coring tool such as 30 for tapping into the delivery pipe 6. The posts 21 also act as a positioning guide for the end 4′ onto the tubular section 5 of the fitting 1. Further, the acute angle A of the tubular section 5 to the axis 12 in FIGS. 1 and 2 permits the flexible hose section 4 to be attached at a gradual angle to the tubular section or insert 5 of the fitting 1 without creating any undesirable sharp bends or kinks in the connecting hose section 4.

It is noted that once the pipe 6 is cored and the tool 30 removed from engagement with the fitting 1, the coring lodged in the head portion 46 of the hollow bit 42 can be easily and quickly ejected to prepare the tool 30 for subsequent use. In this regard and in the illustrated tool 30 at FIG. 12, the hollow bit 42 is slidably mounted on the shaft 50 and biased forward by spring 52. Consequently, once the tool 30 is removed from engagement with the fitting 1, the bit 42 can be manually rotated about the axis 13 to align the pin 54 with the longitudinal channel 56. Sliding the hollow bit 42 rearwardly toward the body 40 of the tool 30 will then cause the tip 50′ of the shaft 50 to contact and eject the coring from the head portion 46 of the bit 42. As previously noted, this ejection action is preferably done with the tool 30 removed from the fitting 1 so that the ejected coring does not fall into the pipe 6 and possibly travel to plug up the sprinkler head 2. The tubular section 5 as indicated above is preferably molded with open ends at 25 and 27 for easier use in the field as neither end then needs to be additionally cored. However, if desired, the end area 25 for example could be initially closed wherein the coring tool 30 would then be used to core through both the end area 25 of the tubular section 5 and the pipe 6.

While several embodiments of the present invention have been shown and described in detail, it to be understood that various changes and modifications could be made without departing from the scope of the invention.

I claim:

1. A fitting (1) for use with a pipe (6) and having an aid primarily intended to accommodate a coring tool, said pipe extending along and about a first axis (12) and having inner and outer, cylindrical surfaces (8,10), said fitting including:
a main body (3) and a hollow, tubular section (5) affixed thereto, said main body having inner and outer surfaces (7,9) extending along and at least partially about a second axis (12′), said inner surface (7) substantially matching and mating with at least a portion of the outer, cylindrical surface (10) of said pipe, said tubular section extending along and about a third axis (13), said second (12′) and third (13) axes being at an acute angle (A) to one another wherein said inner surface of said fitting can be positioned against said matching portion of the outer, cylindrical surface of said pipe with said first (12) and second (12′) axes substantially collinear and the third axis (13) of said tubular section at said acute angle to said first and second axes, and
said tubular section (5) having inner and outer surfaces (15,17) extending along and about said third axis (13), said tubular section of said fitting further having an aid primarily intended to accommodate a coring tool, said aid including at least a pair of posts (21) with each post being affixed to the outer surface (17) of said tubular section and extending away from each other and the outer surface of said tubular section in opposite directions along a fourth axis (23), said fourth axis (23) being substantially perpendicular to said third axis (13) wherein portions (32) of a coring tool (30) can be positioned substantially about said opposing posts (21) to anchor the tool to the fitting and aid the tool in coring said pipe (6) along said third axis (13) between the inner and outer, cylindrical surfaces (8,10) of said pipe (6).

2. The fitting of claim 1 wherein said acute angle is substantially between 15 and 45 degrees.

3. The fitting of claim 1 wherein said acute angle is substantially 30 degrees.

4. The fitting of claim 1 wherein said third (13) and fourth (23) axes intersect one another.

5. The fitting of claim of claim 1 wherein said inner surface of the main body of said fitting extends at least 180 degrees about said second axis.

6. The fitting of claim 1 wherein said inner surface of the main body extends less than 360 degrees about said second axis and more that 180 degrees about said second axis.

7. The fitting of claim 1 wherein the radius of the inner surface of said main body about said second axis is less than the radius of the outer, cylindrical surface of the pipe about the first axis wherein said main body of the fitting can be snapped onto said pipe with said first and second axes thereafter substantially collinear.

8. The fitting of claim of claim 1 wherein said inner surface of said main body is cemented to the outer, cylindrical surface of said pipe.

9. The fitting of claim 1 wherein said fitting is made of rigid plastic.

10. The fitting of claim 9 wherein said rigid plastic is polyvinylchloride.

11. The fitting of claim 1 wherein said pipe is made of rigid plastic.

12. The fitting of claim 11 wherein said rigid plastic is polyvinylchloride.

13. The fitting of claim 1 wherein said tubular section has two, open ends (25,27) spaced from each other along said third axis (13).

14. The fitting of claim 1 further including a coring tool, said coring tool having a body and a bit, said body including at least a pair of clamping members, each clamping member being positionable at least partially about one of said posts to anchor said tool to the tubular section of the fitting, said bit being movable along said third axis to core through said pipe between the inner and outer, cylindrical surfaces thereof.

15. The fitting of claim 14 wherein said clamping members are pivotally mounted to the body of the coring tool for movement about an axis (36) substantially parallel to said fourth axis (23).
